(19) United States
(12) Patent Application Publication
(10) Pub. No.: US 2013/0115364 A1
(43) Pub. Date: May 9, 2013

(54) RESIN-INFILTRATED CERAMICS

(71) Applicant: AmirAli ZANDINEJAD, Louisville, KY (US)

(72) Inventor: AmirAli ZANDINEJAD, Louisville, KY (US)

(73) Assignee: University of Rochester, Rochester, NY (US)

(21) Appl. No.: 13/603,357

(22) Filed: Sep. 4, 2012

Related U.S. Application Data
(60) Provisional application No. 61/530,826, filed on Sep. 2, 2011.

(51) Int. Cl. A61C 13/083; B05D 7/00

(52) U.S. Cl. CPC A61C 13/083; B05D 7/00
USPC 427/2.26

(57) ABSTRACT

Porous ceramic materials, including dental prostheses, may be infiltrated by a solution comprising resin monomers and a solvent for lowering viscosity of the solution. Infiltration may be achieved by providing the ceramic and the solution in a low pressure environment, followed by a polymerizing process whereby the resin is cross-linked within the pores of the ceramic. The solvent may be removed, for example, to leave substantially only the polymerized resin within the ceramic.

### RELATED APPLICATIONS

This application claims priority, pursuant to 35 U.S.C. §119, to U.S. Provisional Patent Application No. 61/530,826, filed Sep. 2, 2011, titled RESIN-INFILTRATED CERAMICS, the entire contents of which are incorporated herein by reference.

### FIELD

The present disclosure relates to enhancement of ceramic materials. In particular, the present disclosure relates to resin infiltration of ceramics to enhance mechanical properties.

### BACKGROUND

Ceramic materials have a variety of applications. Based on the application, certain properties of a ceramic material may be desired, such as strength, flexibility, and durability, biocompatibility, aesthetics, inter alia.

One application for ceramic materials is found in the field of dentistry. Ceramic prostheses may be used as crowns, bridges, dentures, onlay, inlay, veneers, and the like. Such prostheses may be bonded to a tooth or an implant using dental cement. Ceramic prostheses are often used to improve the strength or appearance of teeth.

### SUMMARY

The subject technology is illustrated, for example, according to various aspects described below. Various examples of aspects of the subject technology are described as numbered clauses (1, 2, 3, etc.) for convenience. These are provided as examples, and do not limit the subject technology. It is noted that any of the dependent clauses may be combined in any combination, and placed into a respective independent clause, e.g., clause. The other clauses can be presented in a similar manner.

1. A method, comprising: vaporizing a solution of resin monomers and a solvent, at a pressure lower than atmosphere, in the presence of a porous ceramic, whereby the vaporized solution infiltrates pores of the ceramic; polymerizing the resin monomers within the pores of the ceramic; and removing the solvent from the ceramic by evaporating the solvent.

2. The method of clause 1, wherein the solution further comprises a cross-linking catalyst.

3. The method of clause 2, wherein the cross-linking catalyst comprises benzoyl peroxide.

4. The method of clause 1, wherein the resin monomers include at least one of BisGMA, UDMA, and TEGDM.

5. The method of clause 1, wherein the solution has a lower viscosity than the resin monomers.

6. The method of clause 1, wherein the solvent comprises tetrahydrofuran.

7. The method of clause 1, wherein polymerizing the resin monomers and evaporating the solvent occur substantially simultaneously.

8. The method of clause 1, wherein polymerizing the resin monomers comprises causing the resin monomers to cross-link to form resin polymer chains.

9. The method of clause 1, wherein polymerizing the resin comprises applying at least one of light, heat, and a chemical catalyst.

10. The method of clause 1, wherein polymerizing the resin comprises exposing the resin to a temperature of at least about 45° C.

11. The method of clause 1, wherein the porous ceramic comprises a dental prosthesis.

12. A method, comprising: immersing a porous ceramic in a solution comprising a resin and a solvent; saturating at least a portion of the porous ceramic by reducing pressure around the porous ceramic until the solution is vaporized and permeates pores of the porous ceramic; curing the resin solution within the solution-permeated ceramic and evaporating the solvent of the solution.

13. The method of clause 12, wherein the solution further comprises a cross-linking catalyst.

14. The method of clause 13, wherein the cross-linking catalyst comprises benzoyl peroxide.

15. The method of clause 12, wherein the resin monomer include at least one of BisGMA, UDMA, and TEGDM.

16. The method of clause 12, wherein the solution has a lower viscosity than the resin.

17. The method of clause 12, wherein the solvent comprises tetrahydrofuran.

18. The method of clause 12, wherein curing the resin solution comprises applying at least one of light, heat, and a chemical catalyst.

19. The method of clause 12, wherein curing the resin solution comprises exposing the resin to a temperature of at least about 45° C.

20. The method of clause 12, wherein the porous ceramic is a dental prosthesis.

21. A method, comprising: reducing pressure in a chamber, the chamber containing a dental prosthesis of a porous ceramic material and a resin solution comprising a resin and a solvent, until the resin solution is vaporized and saturates pores of the dental prosthesis; curing the resin within the pores of the dental prosthesis; and removing substantially all of the solvent from the dental prosthesis.

22. The method of clause 21, wherein the solution further comprises a cross-linking catalyst.

23. The method of clause 22, wherein the cross-linking catalyst comprises benzoyl peroxide.

24. The method of clause 21, wherein the resin includes at least one of BisGMA, UDMA, and TEGDM.

25. The method of clause 21, wherein the resin solution has a lower viscosity than the resin.

26. The method of clause 21, wherein the solvent comprises tetrahydrofuran.

27. The method of clause 21, wherein curing the resin and evaporating the solvent occur substantially simultaneously.

28. The method of clause 21, wherein curing the resin comprises applying at least one of light, heat, and a chemical catalyst.

29. The method of clause 21, wherein curing the resin comprises exposing the resin to a temperature of at least about 45° C.

30. A dental prosthesis, comprising: a porous ceramic material; and a polymerized resin infiltrating an outer surface of the porous ceramic material.

31. The dental prosthesis of clause 30, wherein the polymerized resin infiltrates at least 1.5 mm into the ceramic.

32. The dental prosthesis of clause 30, wherein the polymerized resin is a product of a resin solution, comprising resin monomers and a solvent, subjected to a pressurizing process and a curing process.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 shows an overview of materials and processes for producing a resin-infiltrated ceramic.

FIG. 2 shows an SEM image taken of a resin-infiltrated ceramic.

FIG. 3 shows an SEM image taken of a resin-infiltrated ceramic.

FIG. 4 shows an SEM image taken of a ceramic infiltrated from two sides.

FIG. 5 shows an SEM image taken of a non-infiltrated ceramic.

### DETAILED DESCRIPTION

Ceramic materials are used in dentistry and other areas due to their esthetics and relative ease of fabrication. Ceramic materials are effective to mimic the appearance of natural teeth. However, the clinical shortcomings of these materials such as brittleness and crack propagation may limit their use. With millions of prosthetic devices being fabricated in dentistry alone, the failure of even a 5-10% of these devices implies the need for costly remakes.

Some ceramics may be reinforced by adhesive cementation. Adhesive cementation of feldspathic ceramic and glass-ceramic dental restorations may increase flexural strength of ceramic materials. The reinforcing of ceramic by adhesive cementation has been attributed to the resin cement elasticity and the resin-ceramic hybride layer, which under loading or stressing of the system becomes sensitive to the characteristics of the hybride layer. It has been shown that the difference between the Young's modulus of ceramic with resin and tooth structure could be a reason for ceramic crack at the interface between ceramic and the cement. The Young's modulus in a functionally graded material layer (FGM) between ceramic and cement decreases from that of the ceramic at the interface of the ceramic and FGM layer to a lower value at the interface of the FGM layer and the cement layer. This approach can significantly reduce the stress and increase the critical crack length. Further, infiltrating glass into zirconia plates to produce fabricated graded structures reduces the modulus and provided a significant increase in the fracture loads in the infiltrated group.

The present disclosure provides materials and processes to change the mechanical properties of ceramic materials, leading to a decreased propensity for crack propagation and therefore better longevity. This will translate in a material/process that has greater cost/effectiveness for the public.

According to some embodiments, incorporating a polymerized resin into a ceramic structure changes mechanical properties of the material by reducing brittleness and propensity for crack propagation.

According to some embodiments, materials and processes disclosed herein may be applied to one or more porous substrates. For example, ceramic materials may be characterized by pores or open spaces existing or extending there through. A porous ceramic material may be modified by providing substances to the pores thereof.

According to some embodiments, resin-infiltrated ceramics may be used in one or more of a variety of applications. For example, a dental prosthesis may be of a resin-infiltrated ceramic. Reinforcement provided by resin infiltration may enhance the durability and longevity of the dental prosthesis. By further example, materials and processes to produce resin-infiltrated ceramics may be used in a variety of industrial applications to enhance mechanical properties of ceramic materials.

As used herein, “ceramic” means any inorganic nonmetallic solid, including materials having a fully or partly crystalline structure, materials having an amorphous structure (e.g., glass), and combinations thereof (e.g., glass-ceramics). For example, a glass-ceramic having both a glass phase and a crystalline phase may be provided. To increase porosity, at least part of the glass phase may be removed. A ceramic material may be subject to one or more processes, including sintering and etching.

According to some embodiments, examples of ceramic materials include lithium disilicate, lucite glass ceramic, zirconia, canasite ceramic, aluminum oxide, inter alia.

As used herein, “porous” means a characteristic embodied by a material having a nonzero void fraction therein.

According to some embodiments, a porous ceramic material may be provided. The porous ceramic material may be formed in a manner that preserves pores, for example by avoiding excessive sintering during the fabrication process. Further examples include ceramic materials that are treated, at least in part, by acid to create or enhance porosity level. For example, ceramic materials may be treated by hydrofluoric acid (HF), or combinations thereof, with other substances in one of varying concentrations across different time spans. According to some embodiments, a porosity of a ceramic material facilitates resin infiltration.

According to some embodiments, a resin or combination of resins is provided to a porous ceramic material. Examples of resins include bisphenol A diglycidylether methacrylate (BisGMA), urethane dimethacrylate (UDMA), tetraethylene glycol dimethacrylate (TEGDM), and the like. According to some embodiments, the resin, when polymerized, has a lower modulus of plasticity and improved biaxial flexural strength compared to the ceramic material to which the resin is applied. According to some embodiments, the resin is of a biocompatible material. According to some embodiments, a resin is provided as monomers or only partially polymerized to facilitate evaporation and infiltration into a ceramic material.

According to some embodiments, a resin has a given viscosity in liquid form. The viscosity of a resin may be reduced by mixing with a solvent. A resin may be mixed with or dissolved by a solvent to produce a resin solution. The resin solution may have a lower viscosity than that of the resin alone. For example, the resins can be mixed with Tetrahydrofuran (“THF”) or any solvent capable of dissolving a selected resin. For example, solvents may include 2-methyltetrahydrofuran, dimethyl sulphoxide (DMSO), ethanol, a culture medium, distilled water, saline, balanced salt solution, or acetone. According to some embodiments, the solvent is of a biocompatible material.

According to some embodiments, the resin and solvent are provided at a given ratio. For example, the solvent is provided at a concentration high enough to reduce viscosity of the resin solution and facilitate effective infiltration of the resin. Reduced viscosity of the resin solution provides enhanced infiltration into a ceramic material. According to some embodiments, the solvent is provided at a concentration low enough to reduce void fraction remaining in the ceramic material upon evaporation of the solvent. For example, upon infiltration of the resin solution into a ceramic material, a portion of the resin solution (e.g., the solvent) may be removed from the ceramic material by evaporation, for example, leaving substantially only the solute within the void fraction of the ceramic material. Because the solvent fills part of the void fraction upon infiltration, the solvent to be removed after infiltration may be reduced relative to the solute to maintain a substantial amount of void fraction filled by the solute at the end of a process.

According to some embodiments, a cross-linking catalyst is provided in the resin solution. As used herein, “cross-linking catalyst” means any substance configured to facilitate polymerization of a resin during a curing process. For example, a chemical initiator, accelerator, or initiator-accelerator may be provided. One example of a cross-linking catalyst is benzoyl peroxide. Other examples of cross-linking catalysts include Camphorquinone and DMAEMA.

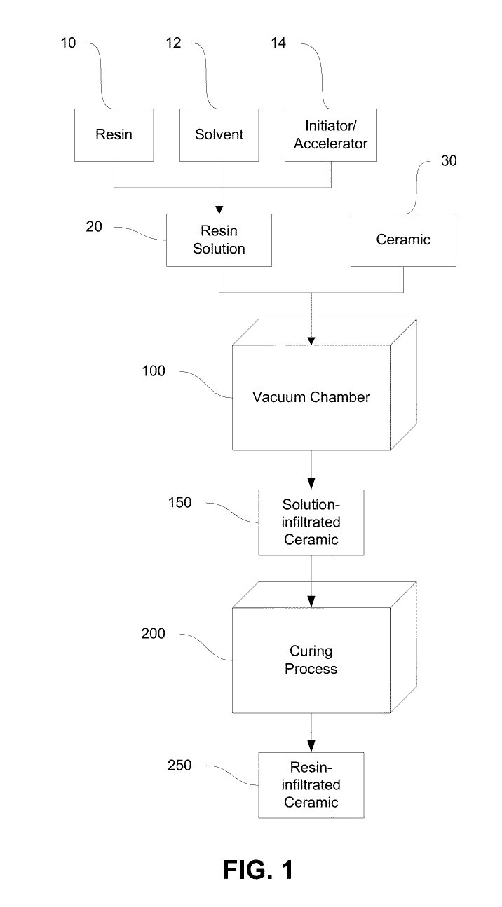

According to some embodiments, as shown in FIG. 1, resin solution 20, comprising one or more of resin 10, solvent 12, and cross-linking catalyst 14, is provided along with ceramic material 30 within vacuum chamber 100. Pressure within vacuum chamber 100 reduces, whereby resin solution 20 evaporates and infiltrates pores of ceramic material 30, producing solution-infiltrated ceramic 150.

According to some embodiments, the pressure within vacuum chamber 100 reduces below atmospheric pressure. For example, the pressure may reduce to vacuum or near vacuum. By further example, the pressure may reduce sufficiently low to cause a resin solution and its constituent parts to evaporate at ambient temperature. According to some embodiments, the pressure within vacuum chamber 100 reduces to a vapor pressure of the resin solution. As used herein, “vapor pressure” means the pressure at which a substance vaporizes at a given temperature. According to some embodiments, vacuum chamber 100 is reduced to equal to or lower than the vapor pressure of at least one constituent part of its contents (e.g., resin 10, solvent 12, etc.). Such pressures are known or determinable for a variety of materials. According to some embodiments, vacuum chamber 100 is reduced to a pressure between atmospheric pressure and approximately a vacuum pressure. According to some embodiments, vacuum chamber 100 is reduced to a pressure between a vapor pressure and approximately a vacuum pressure. Pressure may be reduced to about 1.0×10⁵, 0.9×10⁵, 0.8×10⁵, 0.7×10⁵, 0.6×10⁵, 0.5×10⁵, 0.4×10⁵, 0.3×10⁵, 0.2×10⁵, 0.1×10⁵, or 0.0×10⁵ Pa. A reduction of pressure may be maintained for any duration of time, for example about 5, 10, 15, 20, 25, 30, 35, 40, 45, 50, 55, 60 minutes or more.

According to some embodiments, as shown in FIG. 1, solution-infiltrated ceramic 150 is provided for curing process 200. Curing process 200 may include one or more of chemical reactions, light, and heat. During a curing process, one or more resins of a resin solution may cross-link or polymerize within pores of the ceramic. During the same or a different curing process, at least a substantial amount of a solvent may evaporate. According to some embodiments, a process for polymerizing and a process for evaporating may be performed at different times, at the same time, or in any order.

According to some embodiments, the temperature may be increased at least to a boiling point of the solvent. As used herein, “boiling point” means the temperature at which a substance vaporizes at a given pressure. Such temperatures are known or determinable for a variety of materials. According to some embodiments, curing process 200 may include a step of increasing temperature to about 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., or above. One or more heating steps may be performed in sequence. Each heating step may be performed for any duration of time, for example about 5, 10, 15, 20, 25, 30, 35, 40, 45, 50, 55, 60 minutes or more.

According to some embodiments, curing process 200 produces resin-infiltrated ceramic 250. According to some embodiments, resin-infiltrated ceramics have greater strength and durability than mere ceramics. For example, resin within the pores of the ceramic having a lower modulus of elasticity than the ceramic alone absorb compressive forces applied to the resin-infiltrated ceramic. Accordingly, effects of stress on the ceramic are mitigated, thereby reducing crack formation and propagation and extending operating life of the ceramic.

### Example 1

Semi-sintered Aluminum Oxide (Al₂O₃) ceramic was sectioned with an average thickness of 1.5 mm. The sectioned samples were cleaned with hot steam and then placed in Acetone and subjected to ultrasonic cleaning for 10 minutes to clean the surface of the samples. After cleaning, all samples were placed in a heater (Thermo Scientific, Asheville, N.C.) for 45 minutes in 90° C. in order to dry them.

A one gram resin sample was prepared by mixing BisGMA (ESSTech, Fremont, Calif., Lot #582-44-03) and TEGDMA (ESSTech, Fremont, Calif., Lot #614-23-02) at a ratio of 4:1.

Tetrahydrofuran (THF) (Fisher Scientific, Hampton, N.H., Lot #104284) was added until an acceptable viscosity and consistency was achieved. A total of 2 ml of THF was added to 1 gram mixed resin for proper consistency. Mixing may be performed until a desired consistency or viscosity is achieved (e.g., until flowing off, runny, etc.).

0.01 grams of benzoyl peroxide (Polysciences, Inc., Warrington, Pa., Lot #616832) was added as a heat-curing agent to the diluted resin solution.

Ceramic sections (sliced) were inserted into the resin solution and subjected to negative pressure for infiltration of the ceramic by the resin solution. The ceramic and resin solution was maintained under vacuum pressure for 10 minutes. Further examples included a longer immersion duration (i.e., 20, 30, or 40 minutes), with no measurable impact on the extent or nature of resin infiltration.

Heat curing included maintaining the solution-infiltrated ceramic at 35° C. for 5 minutes, then at 45° C. for 10 minutes, and then raised to 90° C.

The specimens were randomly divided in five groups of 10 each. Group 1 was used as a control, with no further treatment. The second group was infiltrated with glass at 1100° C. for two hours following manufacturer's recommendations. The third, fourth and fifth groups were infiltrated with the experimental resin, as obtained above, under vacuum for different periods of time (Table 1). The ceramic disks previously fabricated were then inserted in the resin under vacuum to allow for resin infiltration. After removing the specimens from the vacuum chamber, they were heat polymerized with the following protocol: 5 minutes at 35° C., then 10 minutes at 45° C., then climb until reaching 90° C.

TABLE 1
Treatment conditions in different groups:

| Group/treatment | # samples: | Treatment | Time | |
|---|---|---|---|---|
| 1 | 10 | None | N/A | |
| 2 | 10 | Glass infiltration | 2 | hr |
| 3 | 10 | Resin Infiltration | 10 | min |
| 4 | 10 | Resin infiltration | 20 | min |
| 5 | 10 | Resin infiltration | 40 | min |

Biaxial flexural strength was tested with a Universal Testing Machine (MultiTest 5-xt, Mecmesin, West Sussex, UK) following ISO standard 6872:1995. Biaxial flexural strength was calculated according to the equation:

$$σ = \frac{- 0.2387 F ( X - Y )}{{d}^{2}}$$

where σ is the maximum center tensile stress in MPa, F is the load at fracture in N, and:

$$X = ( 1 + v ) {ln ( \frac{{r}_{2}}{{r}_{2}} )}^{2} + [ \frac{( 1 - v )}{2} ] {( \frac{{r}_{2}}{{r}_{2}} )}^{2}$$

$$Y = ( 1 + v ) {ln ( \frac{{r}_{1}}{{r}_{2}} )}^{2} + ( 1 - v ) {( \frac{{r}_{2}}{{r}_{2}} )}^{2} ,$$

in which ν is the Poisson's ratio, r₁ is the radius of the support circle in mm, r₂ is the radius of the loaded area in mm, r₂ is the radius of the specimen in mm, and d is the thickness of the specimen at the fracture origin in mm. Poisson's ratio was taken as 0.25 for all ceramics according to the recommendation in the standard.

TABLE 2
Mean of Biaxial flexural strength for different groups:

| | No | | Biaxial Flexural |
|---|---|---|---|
| Group | of samples/Missing Data | Treatment | strength/SD |
| 1 | 10/1 | None | 69.9 ± 4.4 |
| 2 | 10/1 | Glass infiltration | 212 ± 22.4 |
| 3 | 10/0 | Resin Infiltration | 73 ± 5.0 |
| 4 | 10/0 | Resin infiltration | 74.1 ± 3.9 |
| 5 | 10/0 | Resin infiltration | 73.2 ± 4.4 |

Scanning Electron Microscopic (SEM) analysis was carried out, after fracture, on randomly selected samples in each group to observe the infiltration depth of the resin material.

One-way analysis of variance (ANOVA) was used to compare the biaxial flexural strength among 5 groups. Post-hoc Tukey-Kramer test was applied for pair-wise comparison. The significance level was set at 0.05. All statistical analyses were implemented with SAS 9.3 (SAS Institute Inc., Cary, N.C., USA).

TABLE 3
Results from one-way ANOVA:

| Source | DF | SS | MS | F Value | P-value |
|---|---|---|---|---|---|
| Model | 4 | 142216.95 | 35554.24 | 321.16 | <.0001 |
| Error | 43 | 4760.29 | 110.70 | | |
| Corrected Total | 47 | 146977.24 | | | |

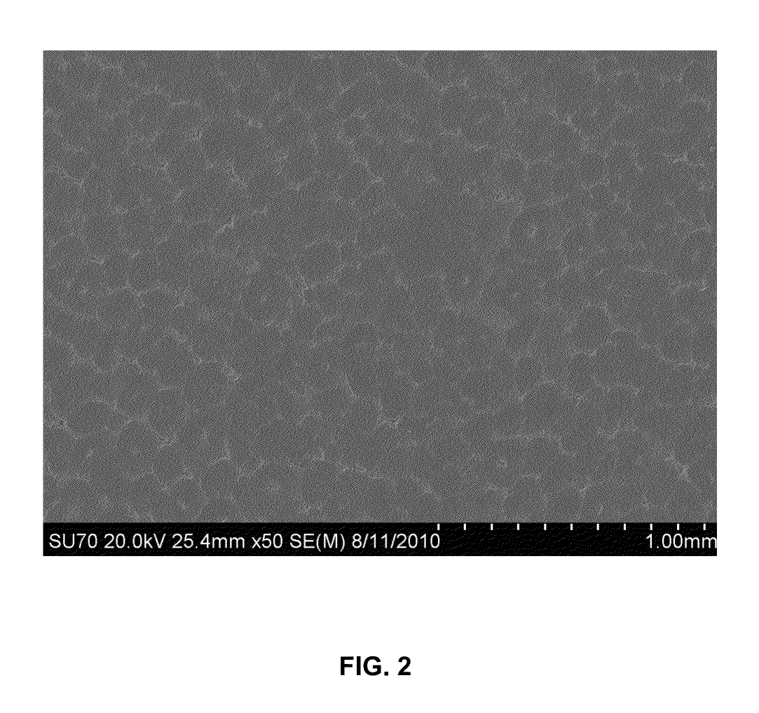

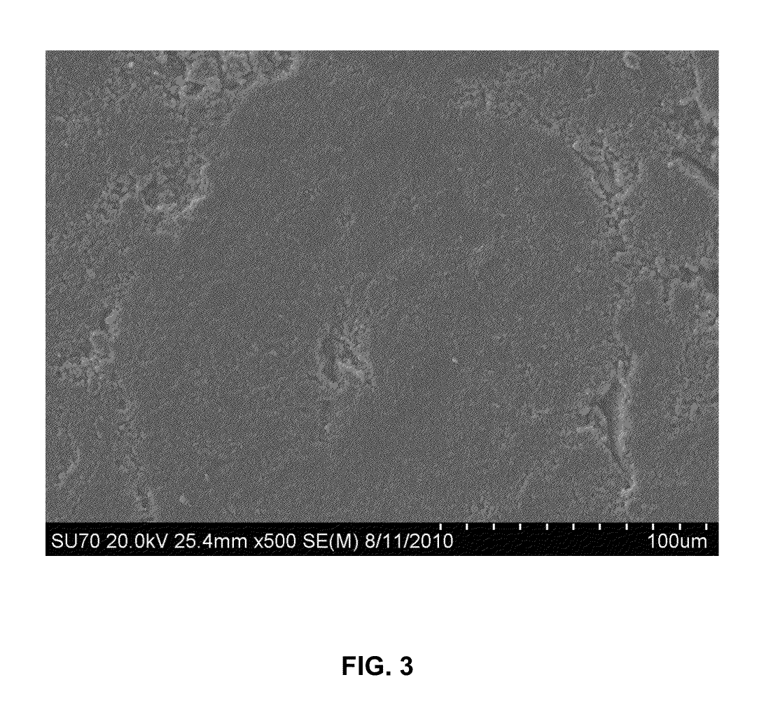

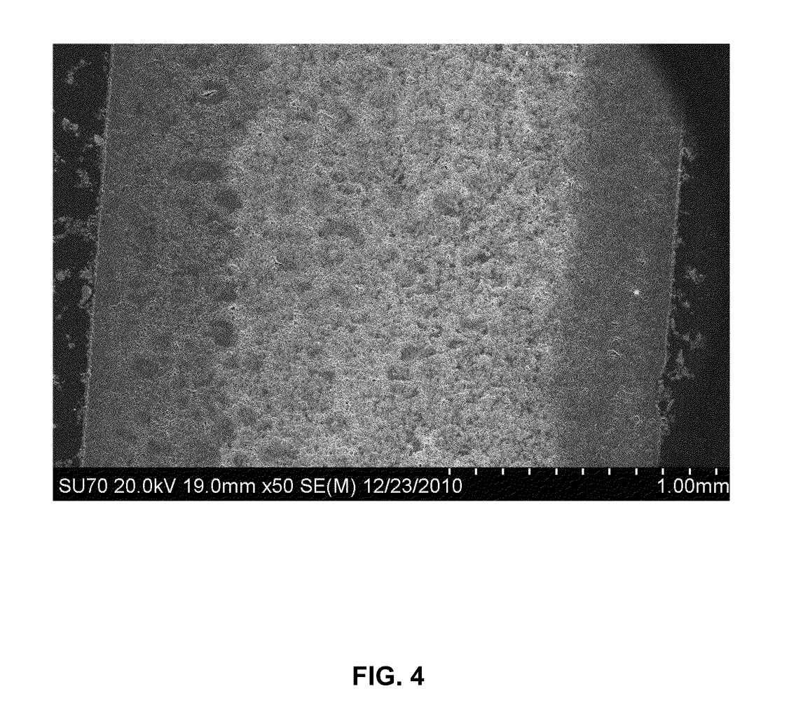

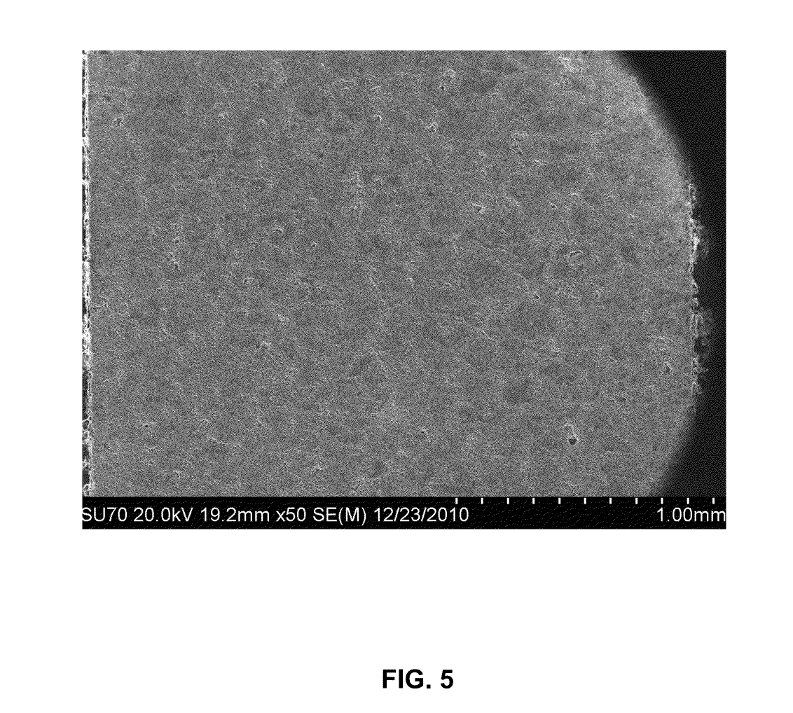

As shown in FIGS. 2 and 3, a scanning electron microscope (SEM) image confirmed that the 1.5 mm section of ceramic was entirely infiltrated by the resin. In further examples, SEM pictures of the fractured samples revealed an available extent of resin infiltration to be approximately 0.6 mm on each side. As shown in FIG. 4, a SEM picture shows the resin penetration on both sides. As shown in FIG. 5, a SEM picture shows a control sample with no infiltration. Porous structure of the ceramic can be observed.

According to embodiments, an extent of resin infiltration may be determined at least in part by a type of resin, an amount of porosity, a solvent resin ratio, and an amount of negative pressure, inter alia. For example, an extent of resin infiltration may be equal to or greater than about 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, or 3.0 mm, as measured from a surface of the implant.

In the foregoing detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A method, comprising:
reducing pressure in a chamber, the chamber containing a dental prosthesis of a porous ceramic material and a resin solution comprising a resin and a solvent, until the resin solution is vaporized and saturates pores of the dental prosthesis;
curing the resin within the pores of the dental prosthesis; and
removing substantially all of the solvent from the dental prosthesis.

2. The method of claim 1, wherein the solution further comprises a cross-linking catalyst.

3. The method of claim 2, wherein the cross-linking catalyst comprises benzoyl peroxide.

4. The method of claim 1, wherein the resin includes at least one of BisGMA, UDMA, and TEGDM.

5. The method of claim 1, wherein the resin solution has a lower viscosity than the resin.

6. The method of claim 1, wherein the solvent comprises tetrahydrofuran.

7. The method of claim 1, wherein curing the resin and evaporating the solvent occur substantially simultaneously.

8. A method, comprising:
vaporizing a solution of resin monomers and a solvent, at a pressure lower than atmosphere, in the presence of a porous ceramic, whereby the vaporized solution infiltrates pores of the ceramic;
polymerizing the resin monomers within the pores of the ceramic; and
removing the solvent from the ceramic by evaporating the solvent.

9. The method of claim 8, wherein the solution further comprises a cross-linking catalyst.

10. The method of claim 8, wherein the resin monomers include at least one of BisGMA, UDMA, and TEGDM.

11. The method of claim 8, wherein the solution has a lower viscosity than the resin monomers.

12. The method of claim 8, wherein the solvent comprises tetrahydrofuran.

13. The method of claim 8, wherein polymerizing the resin monomers and evaporating the solvent occur substantially simultaneously.

14. The method of claim 8, wherein the porous ceramic comprises a dental prosthesis.

15. A method, comprising:
immersing a porous ceramic in a solution comprising a resin and a solvent;
saturating at least a portion of the porous ceramic by reducing pressure around the porous ceramic until the solution is vaporized and permeates pores of the porous ceramic;
curing the resin solution within the solution-permeated ceramic and evaporating the solvent of the solution.

16. The method of claim 15, wherein the solution further comprises a cross-linking catalyst.

17. The method of claim 15, wherein the resin monomer include at least one of BisGMA, UDMA, and TEGDM.

18. The method of claim 15, wherein the solution has a lower viscosity than the resin.

19. The method of claim 15, wherein the solvent comprises tetrahydrofuran.

20. The method of claim 15, wherein the porous ceramic is a dental prosthesis.
